(19) United States
(12) Patent Application Publication
(10) Pub. No.: US 2026/0193390 A1
(43) Pub. Date: Jul. 9, 2026

(54) POLY CHLOROTRIFLUORO ETYLENE COMPOSITIONS AND METHODS OF MAKING THE SAME

(71) Applicant: Solstice Advanced Materials US, Inc., Morris Plains, NJ (US)

(72) Inventors: Jian Hou, Shanghai (CN); Fei Qiao, Shanghai (CN); Hongwei Bai, Shanghai (CN); Echo Li, Buffalo, NY (US)

(73) Assignee: Solstice Advanced Materials US, Inc., Morris Plains, NJ (US)

(21) Appl. No.: 19/431,199

(22) Filed: Dec. 23, 2025

Related U.S. Application Data
(60) Provisional application No. 63/742,484, filed on Jan. 7, 2025.

(51) Int. Cl. C08F 14/24

(52) U.S. Cl. CPC C08F 14/24

(57) ABSTRACT

Compositions and methods of producing the same are provided. In an exemplary embodiment, a composition includes a high temperature PCTFE (poly chlorofluoro ethylene) produced by a high temperature process. The high temperature PCTFE includes some fluorine endcaps. The composition also includes a low temperature PCTFE produced by a low temperature process.

### CROSS-REFERENCE TO RELATED APPLICATIONS

This application claims the benefit of U.S. Provisional Application No. 63/742,484, filed Jan. 7, 2025, the entirety of which is hereby incorporate by reference.

### TECHNICAL FIELD

The present disclosure generally relates to poly chlorotrifluoro ethylene compositions and methods of making the same. More particularly, the poly chlorotrifluoro ethylene compositions comprise blends of different types of poly chlorotrifluoro ethylene compositions.

### BACKGROUND

Fluoropolymers have many benefits and desirable properties that allow for use in a wide variety of industrial and commercial applications. Poly chlorotrifluoro ethylene (referred to herein as PCTFE) has some unique properties compared with other fluoropolymers, such as forming a high gas/moisture barrier, good resistance in low temperature applications such as use with liquid oxygen or other cryogenic applications, and possessing good dimensional stability. Furthermore, PCTFE provides good compatibility with oxygen because it is resistant to ignition. PCTFE has very low reactivity, good resistance to corrosion from strong acids, bases, and oxidizers, and relatively high strength. PCTFE is widely used for corrosion-resistant pipelines, integrated circuits, and pharmaceutical packaging.

PCTFE does have a tendency to discolor or thermally decompose at high temperatures, such as temperatures of about 250 degrees Celsius (° C.). The discoloration temperatures are often reached during processing, such that discoloration can be common. Furthermore, the high crystallinity and large crystal size of PCTFE leads to reduced toughness and poor flexibility.

Accordingly, it is desirable to increase the thermal stability of PCTFE compositions. In addition, it is desirable to increase the toughness and flexibility of PCTFE compositions. Furthermore, other desirable features and characteristics of the present embodiment will become apparent from the subsequent detailed description and the appended claims, taken in conjunction with this background.

### BRIEF SUMMARY

Compositions and methods of producing the same are provided. In an exemplary embodiment, a composition includes a high temperature PCTFE (poly chlorofluoro ethylene) produced by a high temperature process. The composition also includes a low temperature PCTFE produced by a low temperature process.

Another composition is provided in a different embodiment. A pristine poly chlorotrifluoro ethylene (PCTFE) includes carboxylic acid endcaps. The composition includes the pristine PCTFE and a fluorinated PCTFE that has at least some fluorine endcaps.

A method of producing a composition is provided in another embodiment. The method includes providing a pristine poly chlorotrifluoro ethylene (PCTFE) having carboxylic acid endcaps, and producing a high temperature PCTFE by replacing at least some of the carboxylic acid endcaps of the pristine PCTFE with fluorine. This is accomplished at a temperature of from about 210 to about 290 degrees Celsius. The high temperature PCTFE is blended with another PCTFE that is different than the high temperature PCTFE.

### DETAILED DESCRIPTION

The following detailed description is merely exemplary in nature and is not intended to limit the various embodiments or the application and uses of the embodiments described herein. Furthermore, there is no intention to be bound by any expressed or implied theory presented in the preceding technical field, background, brief summary, or the following detailed description.

PCTFE can be prepared in many ways. Typically, it is prepared by combining chlorotrifluoro ethylene as a monomer, and adding an initiator. For example, PCTFE can be produced by providing chlorotrifluoro ethylene in an aqueous suspension at a pH of less than 4, using potassium persulfate as an initiator in the presence of sodium bisulfite and soluble iron phosphate. Alternatively, chlorotrifluoro ethylene can be provided in an aqueous suspension, and the reaction can be initiated with t-butyl hydroperoxide and sodium metabisulfite. Many other techniques are known for the production of PCTFE. PCTFE has been produced in such different manners as bulk, emulsion, and suspension reactions.

The PCTFE produced typically is endcapped with a moiety other than fluorine. For example, in some embodiments the PCTFE is endcapped with carboxylic acid moieties. However, in other embodiments, PCTFE may be endcapped with aldehydes, alcohols, or other moieties. The term “endcapped,” as used herein, refers to a moiety positioned at the end of a polymeric chain. For example, one molecule of PCTFE endcapped by a carboxylic acid would have a carboxylic acid at one end, a chain of carbon atoms reacted to each other with a single bond having, on average, every first carbon atom bound to two fluorine atoms and every second carbon atoms bound to a fluorine and a chlorine atom, and then another carboxylic acid moiety at the opposite end of the polymeric molecule. It is possible for the two ends of a polymeric chain to have different endcaps, such that one end has a carboxylic acid moiety and the other end has a different moiety. Also, some polymers are branched such that there are more than two ends, and each end will terminate with an endcapping moiety.

This discussion is primarily directed to examples of pristine PCTFE that are endcapped with a carboxylic acid moiety. As such, the term “pristine PCTFE,” as used herein, refers to a polymeric chlorotrifluoro ethylene that is primarily endcapped by carboxylic acid moieties. As such, the pristine PCTFE has over ½ of the polymer ends terminating in a carboxylic acid moiety, and may have up to all of the endcaps being a carboxylic acid. It has been noticed that the pristine PCTFE is not thermally stable, and will display discoloration when exposed to high temperatures, such as temperatures of 250° C. or greater. Processing temperatures for the PCTFE are often high enough to produce discoloration. It should be noted that this discussion may also apply to PCTFE compositions that are endcapped with moieties other than a carboxylic acid. Without being bound by theory, it is theorized that the carboxylic acid reacts at higher temperatures to produce the discoloration. This may also be true for other moieties that exist as endcaps for the PCTFE.

The properties of the pristine PCTFE can be improved by blending with certain modified PCTFE compositions. In an exemplary embodiment, the modified PCTFE includes two types of modified PCTFE, including (i) a high temperature PCTFE and (ii) a low temperature PCTFE. Both the high and low temperature PCTFE are produced from the pristine PCTFE, but the properties of the high and low temperature PCTFE are different than that of the of pristine PCTFE.

The high temperature PCTFE is produced by introducing an HT fluorine/nitrogen gas mixture into the space above a sample of pristine PCTFE at desired HT pressure, increasing the temperature to from about 210 to about 290° C., and holding the HT fluorine/nitrogen gas mixture over the pristine PCTFE for a desired HT reaction time. The term “HT” is used herein to indicate the reactants and/or conditions utilized for the high temperature PCTFE, and does not indicate the reactants or conditions are at a high or low temperature beyond what is described herein. At least some of the carboxylic acid endcap moieties of the starting pristine PCTFE are fluorinated to produce the resulting high temperature PCTFE. The HT nitrogen (i.e., N₂) to fluorine (i.e., F₂) gas ratio can vary widely, such as from 99/1 to 1/99, but in alternate embodiments the HT nitrogen to fluorine gas ratio is from about 3 to about 40 volume percent fluorine, or from about 5 to about 20 volume percent fluorine, or from about 10 to about 15 volume percent fluorine. The HT pressure can also vary widely. In an exemplary embodiment, the HT pressure is from about 1 to about 10 bar, but in alternate embodiments the HT pressure may be from about 2 to about 8 bar, or from about 4 to about 6 bar. Other pressures may also be effective. The HT reaction time may vary widely in various embodiments. In an exemplary embodiment, the HT reaction time is about 1 hour or more. The HT reaction time may not have an upper limit, because the reaction may react equilibrium so extended HT reaction times do not result in a change in the reaction products. In alternate embodiments, the HT reaction time is about 2 hours or greater, or about 4 hours or greater, or about 6 hours or greater. The high temperature PCTFE includes some polymeric chains where the carboxylic acid endcap has been replaced with a fluorine endcap.

The low temperature PCTFE is produced by introducing an LT fluorine/nitrogen gas mixture into the space above a sample of pristine PCTFE at a desired LT pressure, increasing the temperature to from about 120 to about 190° C., and holding the LT fluorine/nitrogen gas mixture over the pristine PCTFE for a desired LT reaction time. The term “LT” is used herein to indicate the reactants and/or conditions utilized to produce the low temperature PCTFE, as described above for the term “HT.” At least some of the carboxylic acid endcap moieties of the starting pristine PCTFE are fluorinated to produce the resulting low temperature PCTFE. The LT nitrogen (i.e. N₂) to fluorine (i.e. F₂) gas ratio can vary widely, such as from 99/1 to 1/99, but in alternate embodiments the LT nitrogen to fluorine gas ratio is from about 3 to about 40 volume percent fluorine, or from about 5 to about 20 volume percent fluorine, or from about 10 to about 15 volume percent fluorine. The LT pressure can also vary widely. In an exemplary embodiment, the LT pressure is from about 1 to about 10 bar, but in alternate embodiments the LT pressure may be from about 1 to about 5 bar, or from about 2 to about 4 bar. Other pressures may also be effective. The LT reaction time may vary widely in various embodiments. In an exemplary embodiment, the LT reaction time is about 1 hour or more. The LT reaction time may not have an upper limit, because the reaction may react equilibrium so extended LT reaction times do not result in a change in the reaction products. In alternate embodiments, the LT reaction time is about 2 hours or greater, or about 4 hours or greater, or about 6 hours or greater. The low temperature PCTFE includes some polymeric chains where the carboxylic acid endcap has been replaced with a fluorine endcap.

Both the high temperature PCTFE and the low temperature PCTFE have a higher percentage of fluorine endcaps than the pristine PCTFE, so the term “fluorinated PCTFE,” as used herein, refers to one or both of the high temperature PCTFE and the low temperature PCTFE.

Without being bound by theory, it is believed that some of the polymer chains are severed in the high temperature PCTFE, such that the high temperature PCTFE can be differentiated from the pristine PCTFE by the weight average molecular weight. In a similar manner, the high temperature PCTFE may be differentiated from the low temperature PCTFE based on weight average molecular weights. The different versions of the PCTFE can also be differentiated by the number of carboxylic acid groups present. The end groups, or the endcapping carboxylic acid groups, can be determined by Fourier transfer infra red (FTIR) spectroscopy, which may be performed at standard conditions such as a standard film thickness. The endcap measurement technique described in European Patent EP 0 226 668 B1 provides a standardized technique for determining the quantity of carboxylic acid groups, both as a free acid and associated with a cation, where the carboxylic acid groups are determined based on a number of carbon atoms. Utilizing this testing procedure, it has been determined that the pristine PCTFE has more carboxylic endcaps than the low temperature PCTFE, and the low temperature PCTFE has more carboxylic acid endcaps than the high temperature PCTFE. Without being bound by theory, this difference in the number of carboxylic acid endcaps may be the reason the different types of PCTFE described herein have different properties.

The end group analysis technique described in EP 0 226 668 B1 is reproduced here.

The end groups in a fluorocarbon polymer are determined from the infrared spectrum of compression molded films. This technique has been described in previous patents such as U.S. Pat. No. 3,085,083.

The quantitative measurement of the number of end groups is obtained using the absorptivities measured on model compounds containing the end groups of interest. The end groups of concern, the wavelengths involved, and the calibration factors determined from model compounds are shown below:

| Endgroup | Wavelength, Micrometers | Calibration Factor (CF) |
|---|---|---|
| —COF | 5.31 | 406 |
| —CO₂H(M) | 5.52 | 335 |
| —CO₂H(D) | 5.64 | 320 |
| —CO₂CH₃ | 5.57 | 368 |
| —CONH₂ | 2.91 | 914 |
| —CF═CF₂ | 5.57 | 635 |
| —CH₂OH | 2.75 | 2220 |

M = Monomeric,
D = Dimeric

The calibration factor is a mathematical conversion to give end group values in terms of ends per 106 carbon atoms. The concentration of each type of end in a polymer film may generally be obtained from this equation:

$$\begin{matrix}End groups per & = & \underline{absorbance \times CF} \\ {10}^{6} carbon atoms & \\ & film thickness\end{matrix}$$

where film thickness is in millimeters.

Some of the absorbance peaks may interfere with one another when —CO₂H (D), —CO₂H(M), and —CF═CF₂ ends are all present. Corrections have been developed for the absorbance of —CO₂H (D) (hydrogen-bonded carboxylic acid dimer) and the —CF═CF₂ ends. These are as follows (where u is wavelength in micrometers):

$$\frac{Absorbance 5.46 u - ( 0.3 \times absorbance 5.58 u )}{{CO}_{2} H ( D )} = corrected absorbance for 0.91$$

$$\frac{Absorbance 5.57 u - ( 0.3 \times absorbance 5.58 u )}{CF = {CF}_{2}} = corrected absorbance for - 0.91$$

The presence of —CONH₂ or —CO₂CH₃ may also interfere with the acid and —CF═CF₂ absorbances. Since these groups are generally the result of additives to polymerization their presence is generally predictable. A suspicion of —CONH₂ absorbance in the vicinity of 5.6 micrometers can be checked by searching for the auxiliary —CONH₂ band at 2.91 micrometers.

The polymer films (0.25 to 0.30 mm thick) are scanned on a Perkin-Elmer® 283B spectrophotometer with a film of the same thickness, and known to contain none of the ends under analysis, in the instrument reference beam. The instrument is set up with a Response Time setting of 1, a Scan Time setting of 12 minutes, Ordinate Expansion of 2, a Slit Program of 7, and an Auto-Chek Gain control of 20%. The films are then scanned through the pertinent regions of the spectrum making sure that adequate base lines are established on each side of the pertinent absorbances.

The polymer films are generally compression molded at 270-350° C. The presence of certain salts, particularly alkali metal salts, may cause end group degradation within this temperature range. If these salts are present, the films should be molded a the lowest possible temperature.

The high temperature PCTFE has different properties than the low temperature PCTFE, and thus has a different composition. Blends are made from the pristine PCTFE, the high temperature PCTFE, and the low temperature PCTFE, and these blends can be produced with improved properties.

A multitude of blends are possible with the three different types of PCTFE described herein. For example, pristine PCTFE may be blended with high temperature PCTFE, pristine PCTFE may be blended with low temperature PCTFE, and pristine PCTFE may be blended with a combination of both high temperature PCTFE and low temperature PCTFE. In another embodiment, high temperature PCTFE may be blended with low temperature PCTFE. In some embodiments, the composition includes high temperature PCTFE in an amount of at least about 5 weight percent of the composition, or about 10 weight percent of the composition, or about 30 weight percent of the composition. However, in some embodiments the high temperature PCTFE may be absent from the composition, such that the high temperature PCTFE is 0 percent of the composition. In exemplary embodiments, the composition includes the high temperature PCTFE in an amount of from about 5 to about 30 weight percent of the composition, or from about 10 to about 15 weight percent of the composition.

In a similar manner, the composition includes the pristine PCTFE in an amount of from about 70 to about 95 weight percent of the composition, or from about 75 to about 90 weight percent of the composition, or from about 80 to about 85 weight percent of the composition. The composition may include the low temperature PCTFE in an amount of from 70 to about 95 weight percent of the composition, or from about 75 to about 90 weight percent of the composition, or from about 80 to about 85 weight percent of the composition. In yet other embodiments, the composition may include a combination of the low temperature PCTFE and the pristine PCTFE in an amount of from about 70 to about 95 weight percent, or from about 75 to about 90 weight percent, of from about 80 to about 85 weight percent, all based on the total weight of the composition. The ratio of the low temperature PCTFE to the pristine PCTFE may range from 0/100 to 100/0. For example the pristine PCTFE may comprise 0 percent of the composition, or from about 10 to about 85 weight percent of the composition, or from about 30 to about 70 weight percent of the composition, or from about 70 to about 95 weight percent of the composition, while at the same time the low temperature PCTFE may comprise 0 percent of the composition, or from about 10 to about 85 weight percent of the composition, or from about 30 to about 70 weight percent of the composition, or from about 70 to about 95 weight percent of the composition. Furthermore, it should be understood that, in embodiments where the composition includes from about 70 to 95 weight percent low temperature PCTFE blended with from about 5 to about 30 weight percent high temperature PCTFE that the pristine PCTFE (or other types of PCTFE) may still be included in the blended composition. This also applies to compositions that include from about 70 to about 95 weight percent pristine PCTFE, which may also optionally include low temperature PCTFE or other types of PCTFE.

### Examples

Pristine PCTFE was utilized as a raw material for the production of high temperature PCTFE, and also for the production of low temperature PCTFE.

The high temperature PCTFE was produced as follows. One kilogram (Kg) pristine PCTFE was put into a 10 liter (L) Hastelloy kettle. HT fluorine/nitrogen gas (12% by volume of F₂) was fed to the kettle. The temperature was raised to 240° C. and the HT pressure was raised up to 5 bar. The temperature and HT pressure were maintained for 6 hours. The HT fluorine/nitrogen was released and flushed with nitrogen (N₂) for 1 hour. The kettle was cooled down to room temperature to produce the high temperature PCTFE.

The low temperature PCTFE was produced as follows. One Kg pristine PCTFE was put into a 10 L Hastelloy kettle. LT fluorine/nitrogen gas (12% volume of F₂) was fed to the kettle. The temperature was raised to 160 C and the LT pressure was raised up to 3 bar. The temperature and HT pressure were maintained for 6 hours. The LT fluorine/nitrogen was released and flushed with N₂ for 1 hour. The kettle was cooled down to room temperature to produce the low temperature PCTFE.

Several blends were produced, and the properties tested. The blends were produced as follows. The listed components were combined in a vial in the provided weight ratio. The vial was put into a chamber which was cooled by liquid nitrogen. The listed components were ground using a magnetically driven impactor and the blended composition was produced.

Table 1 below provides the composition of the samples tested, and the results.

TABLE 1

| | | | tensile | | | | |
|---|---|---|---|---|---|---|---|
| | mix ratio, | melt flow | strength, | elongation, | | | |
| Composition | % | index | mPa | % | color L | color a | color b |
| pristine | 100 | 2.07 | 31 | 230 | 77.82 | 0.34 | 5.12 |
| LF | 100 | 1.995 | 30 | 220 | 80.91 | 0.78 | 1.54 |
| HF | 100 | 21.325 | 40 | 15 | 81.72 | 0.62 | 1.32 |
| pristine/ | 85/15 | 3.395 | 33 | 295 | 78.94 | 0.58 | 3.25 |
| HF | | | | | | | |
| LF/HF | 90/10 | 2.42 | 32 | 260 | 80.89 | 0.73 | 1.52 |
| LF/HF | 85/15 | 3.535 | 32 | 280 | 80.25 | 0.83 | 1.58 |

Pristine stands for pristine PCTFE, as described herein.
LF stands for low temperature PCTFE
HF stands for high temperature PCTFE
Melt flow index is provided in grams per minute (g/min)
mPa stands for millipascals.
The color values are the L*, a*, and b* values from the CIELAB, as defined by the International Commission of Illumination.

The melt flow index was determined as follows. A 20.0 gram (g) sample is charged to a 10 millimeter (mm) inside diameter cylinder, which is maintained at 270° C.°. Five minutes after the sample is charged to the cylinder, the sample is extruded through a 2.10 mm diameter by 10.00 mm long square-edge orifice under a load (piston plus weight) of 2160 grams. Every 2 minutes the extrudate is collected and weighed. Melt flow rate values are calculated in g/10 min.

Thin sheets for other test properties were prepared as follows. A 20 centimeter (cm) by 20 cm opening is cut in the middle of a 25 cm by 25 cm by 0.2 millimeters (mm) thick metal sheet to form a chase. The chase is placed on a 40 cm by 40 cm by 3 mm thick molding plate and covered with Kapton® film that is slightly larger than the chase. 15.00 grams of polymer sample is spread uniformly within the mold opening. A second piece of Kapton film that is slightly larger than the chase is placed on top of the sample and a second molding plate, which has the same dimensions as the first, is placed on top of the Kapton film to form a mold assembly. The mold assembly is placed in a hot press that is set at 270° C. The hot press is closed so the plates are just contacting the mold assembly and held for 5 minutes. The pressure on the hot press is then increased to 10 MPa and held for an additional 10 minute. The mold assembly is removed from the hot press, placed between another press that is maintained at ambient temperature, the pressure is increased to 10 MPa, and the mold assembly is left in place for 5 minutes to cool with cooling water. The mold assembly is then removed from the ambient temperature press, and the sample sheeting is removed from the mold assembly.

Tensile properties were tested using bubble-free areas of the sample sheeting that were stamped out using a dumbbell cutter. The tensile properties are tested according to ASTM D882. Color properties were tested using bubble-free areas of the sample sheeting that were stamped out using a square cutter. Two of the sheeting squares are assembled on top of each other to create a stack and the sheeting stack is placed in a CR-400 spectrophotometer made by Konica Minolta® for testing.

The following values are desired. The melt flow index should be between 1 and 10 g/10 min. The tensile strength should be between 30 and 40, with higher values being preferred. Higher values for elongation are preferred. Higher values for the color L values are preferred. Lower values for the color b values are preferred. As can be seen, pure samples of the high temperature PCTFE have a melt flow index that is too high, and the elongation percentage is quite low, which indicates the product is brittle. This melt flow index value is reduced when the high temperature PCTFE is blended with either the pristine or low temperature PCTFE samples, and the elongation percentage increases significantly. The pristine PCTFE has a large color b* value and a low color L* value, and these color values are improved when blended with the high temperature PCTFE. The pristine and low temperature PCTFE both have tensile strengths that are marginally acceptable, but the tensile strengths and elongation at break of both samples are improved in the blended samples.

The pristine, high temperature, and low temperature PCTFE were tested for the number of carboxylic end groups per the procedure mentioned above, and provided in European Patent EP 0 226 688 B1, Paragraphs 41-47. The testing was done using FTIR spectroscopy (FTIR NICOLET® 5700 spectrometer) at a film thickness of 250 micrometers (um), as indicated in EP 0 226 668 B1. The end groups mentioned in the following samples are the sum of the free and associated carboxylic acid groups per 106 carbon atoms.

| | |
|---|---|
| Pristine PCTFE | 710 |
| Low temperature PCTFE | 537 |
| High temperature PCTFE | 425 |

While several embodiments have been presented in the foregoing detailed description, it should be appreciated that a vast number of variations exist. It should also be appreciated that the embodiment or embodiments are only examples, and are not intended to limit the scope, applicability, or configuration of this disclosure in any way. Rather, the foregoing detailed description will provide those skilled in the art with a convenient road map for implementing various embodiments of the compositions, it being understood that various changes may be made in the function and arrangement of elements described without departing from the scope as set forth in the appended claims and their legal equivalents.

What is claimed is:

1. A composition comprising:
a high temperature PCTFE (poly chlorotrifluoro ethylene) produced by a high temperature process; and
a low temperature PCTFE produced by a low temperature process.

2. The composition of claim 1, wherein the high temperature PCTFE is present in an amount of from about 5 to about 30 weight percent, based on a total weight of the composition; and
the low temperature PCTFE is present in an amount of from about 70 to about 95 weight percent, based on the total weight of the composition.

3. The composition of claim 1, wherein the high temperature PCTFE has a higher percentage of fluorine endcaps than a pristine PCTFE.

4. The composition of claim 3, wherein the low temperature PCTFE has a lower percentage of fluorine endcaps than the high temperature PCTFE.

5. The composition of claim 1, further comprising a pristine PCTFE, where the pristine PCTFE comprises carboxylic acid endcaps, and where the pristine PCTFE has a lower percentage of fluorine endcaps than the high temperature PCTFE, and the pristine PCTFE has a lower percentage of fluorine endcaps than the low temperature PCTFE.

6. The composition of claim 1, wherein the high temperature PCTFE is present in an amount of from about 10 to about 15 weight percent, based on a total weight of the composition.

7. A composition comprising:
a pristine poly chlorotrifluoro ethylene (PCTFE), wherein the pristine PCTFE comprises carboxylic acid endcaps; and
a fluorinated PCTFE, wherein the fluorinated PCTFE comprises fluorine endcaps.

8. The composition of claim 7, wherein the fluorinated PCTFE comprises a high temperature PCTFE, and wherein the high temperature PCTFE has more fluorine endcaps than the pristine PCTFE.

9. The composition of claim 8 comprising from about 70 to about 95 weight percent of the pristine PCTFE, based on a total weight of the composition.

10. The composition of claim 9 comprising the high temperature PCTFE in an amount of from about 5 to about 30 weight percent, based on the total weight of the composition.

11. The composition of claim 8, wherein the fluorinated PCTFE further comprises a low temperature PCTFE, wherein the low temperature PCTFE has a higher percentage of fluorine endcaps than the pristine PCTFE, and the high temperature PCTFE has a higher percentage of fluorine endcaps than the low temperature PCTFE, and wherein the composition comprises the pristine PCTFE, the high temperature PCTFE, and the low temperature PCTFE.

12. The composition of claim 11 comprising a mixture of the pristine PCTFE and the low temperature PCTFE, wherein the mixture of the pristine PCTFE and the low temperature PCTFE comprise from about 70 to about 95 weight percent of the composition, based on a total weight of the composition.

13. A method of producing a composition comprising:
providing a pristine poly chlorotrifluoro ethylene (PCTFE) having a carboxylic acid endcap;
exposing the pristine PCTFE to a gas comprising fluorine and nitrogen at a temperature of from about 210 to about 290 degrees Celsius to produce high temperature PCTFE; and
blending the high temperature PCTFE with a type of PCTFE that is different than the high temperature PCTFE.

14. The method of claim 13, wherein blending the high temperature PCTFE with the type of PCTFE that is different than the high temperature PCTFE comprises blending the high temperature PCTFE with the pristine PCTFE.

15. The method of claim 14, further comprising:
producing the composition wherein the high temperature PCTFE is present in an amount of from about 5 to about 30 weight percent.

16. The method of claim 13 further comprising:
exposing the pristine PCTFE to a gas comprising fluorine and nitrogen at a temperature of from about 120 to about 190 degrees Celsius to produce low temperature PCTFE; and
blending the low temperature PCTFE with the high temperature PCTFE.

17. The method of claim 16, further comprising:
producing the composition wherein the low temperature PCTFE is present in an amount of from about 70 to about 95 weight percent.

18. The method of claim 16 further comprising:
blending the high temperature PCTFE with a combination of the low temperature PCTFE and the pristine PCTFE to produce the composition wherein the high temperature PCTFE is present in an amount of from about 5 to about 30 weight percent, based on a total weight of the composition.

19. The method of claim 16, wherein:
producing the high temperature PCTFE comprises producing the high temperature PCTFE having a higher percentage of fluorine endcaps than the pristine PCTFE; and
producing the low temperature PCTFE comprising producing the low temperature PCTFE with a higher percentage of fluorine endcaps than the pristine PCTFE, and with a lower percentage of fluorine endcaps than the high temperature PCTFE.

20. The method of claim 13, wherein producing the high temperature PCTFE comprises producing the high temperature PCTFE having a higher percentage of fluorine endcaps than the pristine PCTFE.
